(19) United States
(12) Patent Application Publication
(10) Pub. No.: US 2003/0046430 A1
(43) Pub. Date: Mar. 6, 2003

(54) Method, system and program for transforming data

(76) Inventors: Kosuke Iwade, Kawasaki (JP); Hirotaka Enokizono, Yokohama (JP); Satoshi Yamaguchi, Yamato (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/147,879

(22) Filed: May 20, 2002

(30) Foreign Application Priority Data
Jul. 11, 2001 (JP) 2001-210144

(51) Int. Cl. G06F 15/16

(52) U.S. Cl. 709/246

(57) ABSTRACT

Transform rule information which defines transform rules of common data items defined generally in common within a composite system and uniquely identifiable input/output data of system is previously managed and a necessary transform rule is extracted on the basis of data defining combination of system and common data upon construction of the composite system. The transform rule required to transmit and receive data between the plurality of systems is extracted to thereby reduce a transform processing cost and maintenance time and labor for change in specifications of the system.

### BACKGROUND OF THE INVENTION

The present invention relates to data transform technique relative to transmission and reception of data between systems and required for development of a composite system composed of a plurality of computer systems of different kinds operating in cooperation with one another.

Recently, the technique for constructing the composite system inexpensively in a short term which provides new business or work function by operating computer systems of different kinds in cooperation with one another is widely noticed. The systems of different kinds have different data formats such as data structure, data type and code system of data to be treated. In order to transmit and receive data between the systems of different kinds, it is indispensable to transform the data format between the systems of different kinds.

To this end, the technique for performing data transform in accordance with the data transform rule between the systems of different kinds defined by the operator and the technique for automatically producing the program for performing data transform in accordance with the data transform rule have been developed.

In these techniques, for example, data formats of systems A and B different from each other are read in as schema and the correspondence of data items between the systems A and B is decide by the operator of the composite system to thereby define the transform rule.

In order to decide the correspondence between the data items, however, the knowledge concerning the data formats of the systems A and B is required to the operator.

Further, when a system C which receives data from the system A is introduced newly and the systems A and C are operated in cooperation with each other, the operator of the composite system having the knowledge of the data formats of both the systems A and C is required to perform operation for deciding the correspondence between the data items.

Moreover, in this state, when the system A is changed to a system A′, it is necessary to modify both of the definition of the transform rule of the data formats between the systems A and B and the definition of the transform rule of the data formats between the systems A and C to correspond to the system A′.

Accordingly, in the method disclosed in U.S. Pat. No. 5,708,828 (Reference 1), when the data format of the system A is transformed to the data format of the system B, intermediate data of general-purpose and common type is defined by the operator of the composite system, so that data of the system A is once transformed into the intermediate data on the basis of the transform rule from the data format of the system A to the format of the intermediate data defined by the operator of the composite system and the intermediate data is transformed into data of the system B on the basis of the transform rule from the format of the intermediate data to the data format of the system B defined by the operator.

According to this method, the operator of the composite system defines the transform rule of the data formats of the respective systems to be operated in cooperation and the format of the intermediate data defined by the operator himself of the composite system.

Accordingly, a form of operation that the operator of the composite system having the knowledge concerning the system A defines the transform rule of the data format of the system A and the format of the intermediate data and the operator of the composite system having the knowledge concerning the system B defines the transform rule of the format of the intermediate data and the data format of the system B can be realized, so that not only the individual operators are not required to have the knowledge concerning all the systems relative to the cooperative operation but also these operations can be performed simultaneously in parallel.

Further, even if the system A is changed to a new system A′ when data from the system A is received by a plurality of systems such as systems A and B, only the transform rule of the data format of the system A and the format of the intermediate data may be modified.

Moreover, JP-A-2000-23356 (Reference 2) discloses another data transform method that transform is performed without preserving the intermediate data. This method derives the transform rule for transforming data directly without using the intermediate data format on the basis of the definition of the intermediate data format, the definition of the transform rule from the data formats of the respective systems to the intermediate data format and the definition of the transform rule from the intermediate data format to the data formats of the respective systems.

For example, the operator of the composite system defines the format of the intermediate data, the transform rule between the data format of the system A and the format of the intermediate data and the transform rule between the format of the intermediate data and the data format of the system B and derives the rule for directly transforming the data format of the system A into the data format of the system B on the basis of these definitions.

Thus, the form of operation that the operator of the composite system having the knowledge concerning the system A defines the transform rule of the data format of the system A and the format of the intermediate data and the operator of the composite system having the knowledge concerning the system B defines the transform rule of the format of the intermediate data and the data format of the system B can be realized, so that not only the individual operators are not required to have the knowledge concerning all the systems relative to the cooperative operation but also these operations can be performed simultaneously in parallel.

Further, in this method, even if the system A is changed to a new system A′ when data from the system A is received by a plurality of systems such as systems B and C, only the transform rule from the data format of the system A to the format of the intermediate data is modified to the transform rule of the data format of the system A′ and the intermediate data format to thereby derive the transform rules automatically so that the transform rule from the data format of the system A′ to the data format of the system B and the transform rule from the data format of the system A′ to the data format of the system C can be obtained.

### SUMMARY OF THE INVENTION

It is an object of the present invention to provide a data transform method and system in which a minimum transform rule required to transmit and receive data among a plurality of systems is extracted to thereby make it possible to reduce maintenance time and labor for change in specifications of the system.

In the method of once preparing the intermediate type data as in the Reference 1, since the system A delivers data to many and unspecified systems, it is necessary to transform all of output data of the system A into the intermediate format and store it. That is, there is a problem that a cost for transforming unnecessary data which is not utilized even in any system is required and a storage area for storing the unnecessary data must be ensured in vain. Further, since the intermediate data is prepared in the batch processing way, there occurs a time lag between the data update timing in the system and the preparation timing of the intermediate data, so that there is a case where the latest data is not always reflected to the intermediate data.

Further, even in the method of directly transforming the cooperation data as in the Reference 2, for example, when the case where specifications or the like of the system A are changed and the “transform rule A”, for example, concerning the system A must be modified due to the change is considered, a plurality of transform rules derived on the basis of the “transform rule A” in the business or work system are considered and accordingly the operator is required to extract all of the transform rules derived on the basis of the “transform rule A” if the “transform rule A” is modified. In addition, it is necessary to derive respective transform rules on the basis of the modified transform rule again. That is, the more the transform rules to be modified due to the change of the system, the more the excessive burden on the operator engaged in the modification.

In the present invention, uniquely identifiable systems are divided into input systems and output systems to be defined and an operator defines data item to be delivered from the input system to the output system using common data item defined generally in common within a composite system to store it in a system cooperation information management unit. On the other hand, the operator defines a transform rule for each system and common data item and the transform rule is stored in a transform rule information management unit. Thus, a necessary transform rule is extracted from the transform rule information management unit on the basis of the system cooperation information automatically. With regard to loading of the transform rule, it may be loaded so that intermediate data is preserved actually or it may loaded by deriving the transform rule for directly transforming data from the transform rule of the input system and the output system without intermediate data. When it is loaded so that the intermediate data is preserved, the common data item can be utilized for definition of format of the intermediate data. That is, the present invention can provide a structure of concealing the transform rule by the system cooperation information and extracting a requisite minimum transform rule separately.

According to the present invention, when the transform rule is loaded so that the intermediate data is preserved, only the requisite minimum transform rule is extracted for each system cooperation and accordingly the intermediate data stored in a memory area can be always at the minimum.

Further, when the transform rule is loaded by deriving the transform rule for directly transforming data without intermediate data, the transform rule to be re-loaded can be retrieved to be outputted automatically on the basis of the system and the common data item if the transform rule information is modified. Moreover, when the transform rule not modified and the transform rule modified are both designated, derivation of the transform rule can be automatically made again at the same time as extraction of the system cooperation mode to be modified.

The minimum transform rule required to transmit and receive data between the plurality of systems can be extracted to thereby reduce maintenance time and labor for change in specifications of the system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating an embodiment of the present invention;

FIG. 2 is a table showing a first example of system input/output data item information;

FIG. 3 is a table showing a first example of system cooperation information;

FIG. 4 is a table showing a second example of system cooperation information;

FIG. 5 is a table showing a first example of common data item information;

FIG. 6 is a table showing a first example of transform rule information;

FIG. 7 is a flow chart showing a processing procedure of system input/output data definition;

FIG. 8 shows an example of a system input/output data definition picture;

FIG. 9 is a flow chart showing a processing procedure of system cooperation definition;

FIG. 10 shows an example of a system cooperation definition picture;

FIG. 11 is a flow chart showing a processing procedure of common data item definition;

FIG. 12 shows an example of a common data item definition picture;

FIG. 13 is a flow chart showing a processing procedure of transform rule definition;

FIG. 14 shows an example of transform rule definition picture;

FIG. 15 is a flow chart showing a processing procedure of extracting a transform rule;

FIG. 16 is a table showing a third example of system cooperation information;

FIG. 17 is a table showing a second example of transform rule information;

FIG. 18 is a flow chart showing a processing procedure of re-extracting a transform rule;

FIG. 19 is a table showing a third example of transform rule information;

FIG. 20 is a table showing a fourth example of system cooperation information;

FIG. 21 is a table showing a fifth example of system cooperation information;

FIG. 22 is a table showing a sixth example of system cooperation information; and

FIG. 23 is a table showing a fourth example of transform rule information.

### DESCRIPTION OF THE EMBODIMENTS

Embodiments of the present invention are now described in detail with reference to the accompanying drawings.

It is an object to provided the method in which a requisite minimum transform rule is extracted to thereby suppress a transforming cost required when intermediate data is stored and a storage area for storing the intermediate data to the requisite minimum in the cooperative operation of a system. Further, it is an object to provide a method in which a transform rule to be modified when data is transformed directly is detected and the transform rule is derived again even for change in specifications of the system.

Terms used in the embodiments of the present invention are first defined. “System” is a computer system and means application programs, middleware, database and the like provided in the computer. Input and output of data of the system are made by means of an interface decided uniquely in the system or by means of an adapter for converting input/output of data into event. “Data format” means a format of data previously defined by the system or the operator such as data structure, type and code system. “Data item” means a variable defined in common to be identifiable uniquely in the system and for treating data. “System of different kind” means the system having the data format treated which is different from that treated in other systems. “Composite system” means the system constructed by cooperative operation of the plurality of systems of different kinds. “Common data item” means a variable defined generally in common to be identifiable uniquely in the composite system and for treating data. The data format of the common data item is not limited specifically. “Common data” means data treated in the common data item. “Cooperation of systems” means that a plurality of systems of different kinds transmit to and receive data from one another at a certain timing. “System cooperation data” represents a definition of the cooperation of systems and is expressed a combination of system name and common data item name.

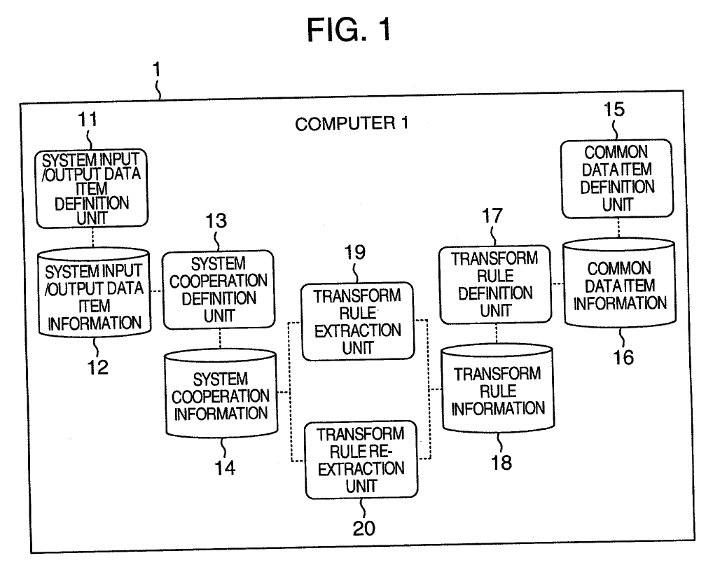

FIG. 1 is a block diagram schematically illustrating an embodiment in which the present invention is applied to transmission and reception of data between systems of different kinds.

In FIG. 1, numeral 1 denotes a computer including a CPU having sequential execution function based on programs, a memory for storing the programs and data upon execution of the programs, a magnetic storage unit for recording programs and data and an input/output unit having a keyboard and a television display. Acquisition and restoration of data with regard to the magnetic storage unit may be made by data transfer from the outside of the computer 1 by means of a network such as LAN.

A system input/output data item definition unit 11 is operated in the computer 1 and has the function of causing the operator to use the system and common data item and input the definition of data items required to be inputted in processing performed by the system and data items outputted by the processing.

Numeral 12 denotes system input/output data item information which exists in the computer 1 and includes in the form of table described later the definition of the system input/output data item inputted by the operator by means of the system input/output data definition unit 11.

A system cooperation definition unit 13 is operated in the computer 1 and has the function of causing the operator to use the system and common data items and input the definition for cooperation of systems.

Numeral 14 denotes system cooperation information which exists in the computer 1 and includes in the form of table described later the definition for cooperation of systems inputted by the operator by means of the system cooperation definition unit 13 and a storage location of a transform rule execution file extracted and produced by means of a transform rule extraction unit 20 described later.

A common data item definition unit 15 is operated in the computer 1 and has the function of causing the operator to input the definition of common data items.

Common data item information 16 exists in the computer 1 and includes in the form of table described later the definition of common data items inputted by the operator by means of the common data item definition unit 15.

A transform rule definition unit 17 is operated in the computer 1 and has the function of causing the operator to input the definition of the transform rule for common data item and input/output data item of the system.

Transform rule information 18 exists in the computer 1 and includes in the form of table described later the definition of the transform rule inputted by the operator by means of the transform rule definition unit 17.

A transform rule extraction unit 19 is operated in the computer 1 and has the function of extracting the necessary transform rule from the transform rule information on the basis of the system cooperation information and producing a file required for execution of the transform rule.

A transform rule re-extraction unit 20 is operated in the computer 1 and has the function of confirming whether the transform rule execution file is produced by the transform rule extraction unit 20 while using the transform rule or not when definition contents of the transform rule included in the transform rule information 18 designated by the operator are modified and producing the transform rule execution file again on the basis of the modified transform rule.

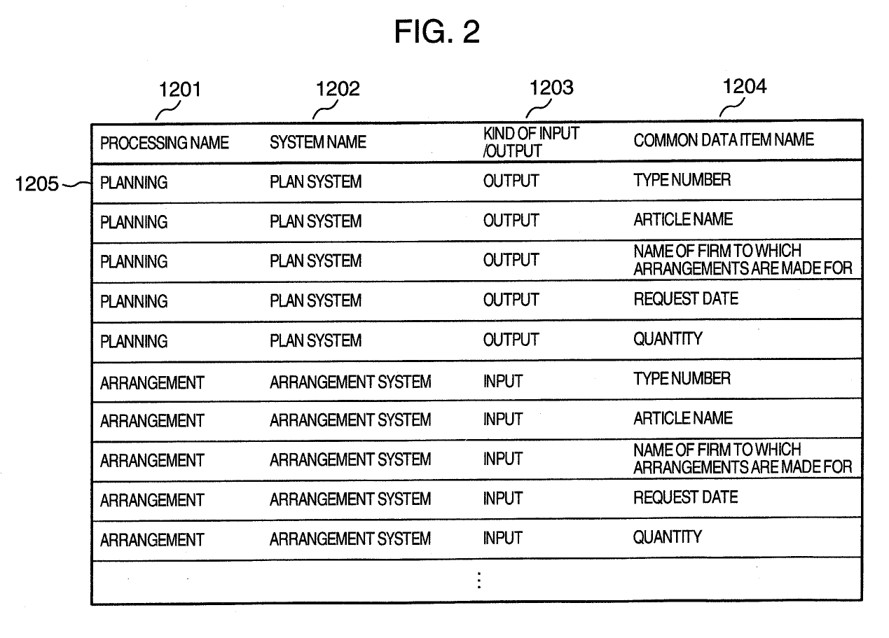

Referring now to FIGS. 2 to 6, data item and data used as an example in the embodiment are described.

FIG. 2 shows an example of contents of the system input/output data item information 12.

FIG. 2 shows an example of table definition information including processing name 1201 for uniquely identifying processing, system name 1202 of systems utilized in the processing, kind of input/output 1203 representing kind of input or output of the common data item in the system, and common data item name 1204 transformable from the data item inputted or outputted in the system in corresponding manner in the embodiment. For example, a record denoted by 1205 means that “in ‘planning processing’, data transformable to the common data item “type number” is “outputted” in a ‘planning system’”.

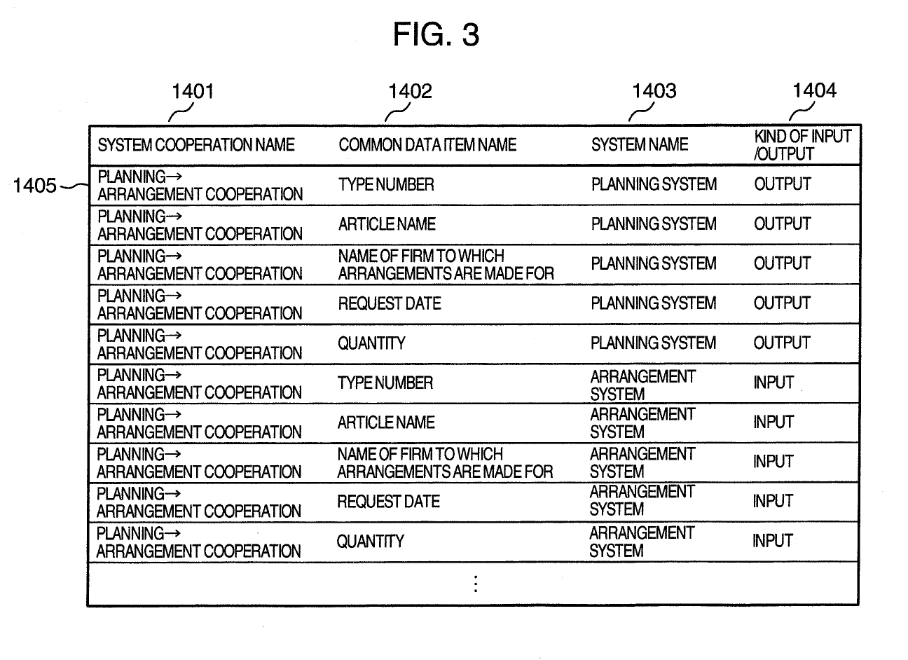

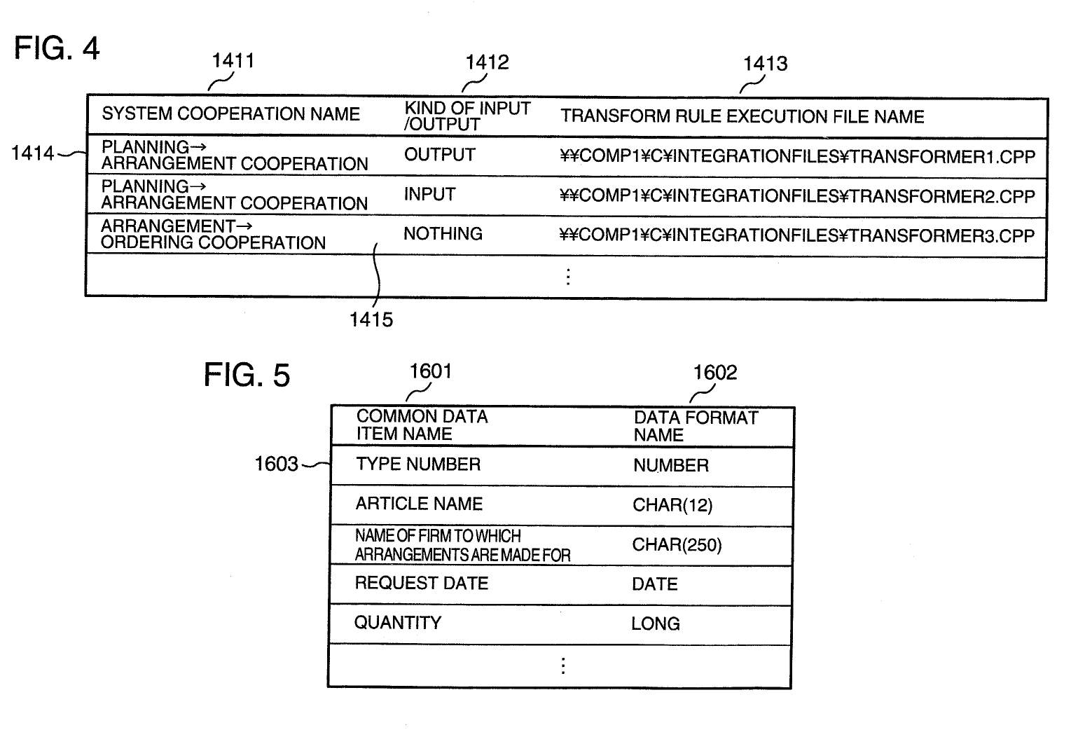

FIGS. 3 and 4 show examples of contents of the system cooperation information 14.

FIG. 3 shows an example of table definition information including system cooperation name 1401 for uniquely identifying cooperation of the system, common data item name 1402 representing data item to be delivered in the system cooperation, system name 1403 of the system which delivers the common data, and kind of input/output 1404 representing a kind as to whether the system is a source of delivery or destination of delivery in corresponding manner in the embodiment. For example, a record denotes by 1405 means that “in ‘planning→arrangement cooperation’, data ‘outputted’ from ‘planning system’ is transformed into ‘type number’”.

FIG. 4 shows an example of table definition information including system cooperation name 1411 for uniquely identifying system cooperation, kind of input/output 1412 representing kind of output of data from the system or input of data to the system in the system cooperation, and transform rule execution file name 1413 extracted and produced by the transform rule extraction unit 20 in corresponding manner in the embodiment. The transform rule execution file name 1413 is desirably defined so that a preservation location of the file is specified. For example, a record denoted by 1414 means that in “planning→arrangement cooperation”, the transform rule execution file utilized in “output” of data is “¥¥COMP1¥C¥INTEGRATIONFILES¥TRANSFORMER1”. Further, there is a case where “nothing” is entered in the kind of input/output 1412 as shown by 1415 and this means production of one transform rule execution file for performing system cooperation between systems directly. This will be described in detail in the embodiment of the transform rule extraction unit 19 described later.

FIG. 5 shows an example of contents of the common data item information 16.

FIG. 5 shows an example of table definition information including common data item name 1601 for uniquely identifying common data item, and data format name 1602 of the common data item in corresponding manner in the embodiment. For example, a record denoted by 1603 means that “the data format of ‘type number’ of the common data item is ‘NUMBER’”.

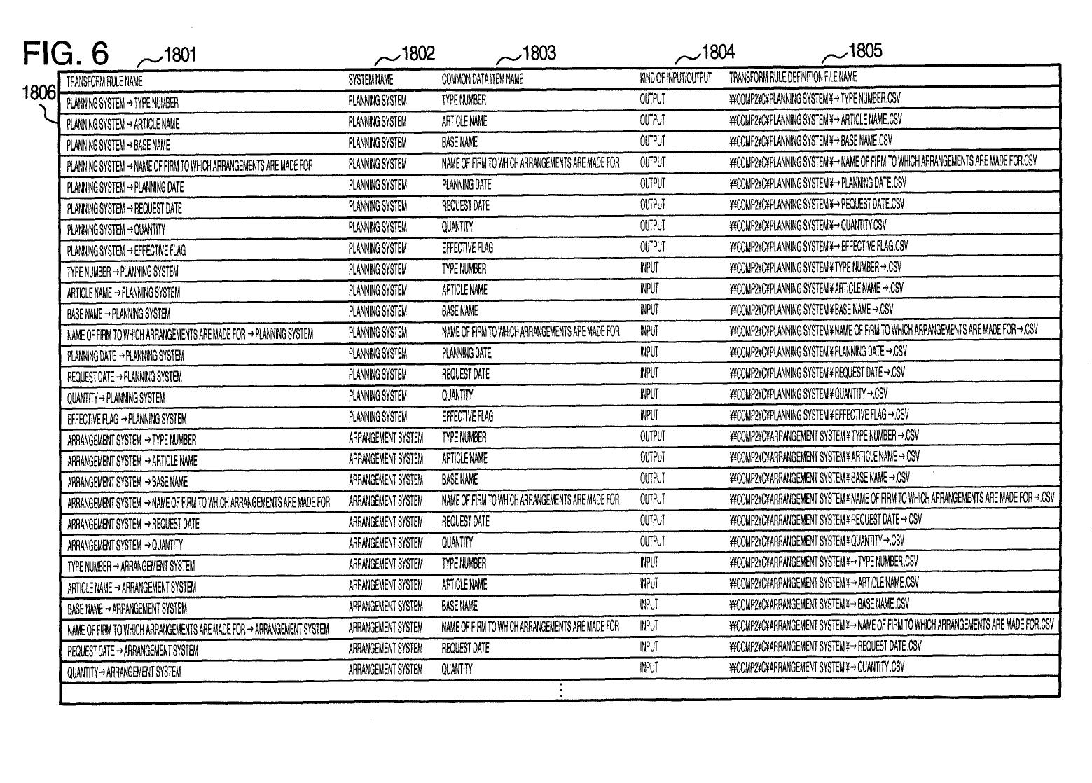

FIG. 6 shows an example of contents of the transform rule information 18.

FIG. 6 shows an example of table definition information including transform rule name 1801 for uniquely identifying transform rule, system name 1802 of the system utilized in the transform rule, common data item name 1803 transformable from data item inputted or outputted in the system, kind of input/output 1804 representing kind of input or output of the common data item in the system, and transform rule definition file 1805 produced by the transform rule definition unit 17 in corresponding manner in the embodiment. The transform rule definition file 1805 is desirably defined so that a preservation location of the file is specified. Further, in this example, definition contents of the transform rule are preserved as file, although it is not limited thereto particularly. For example, a record denoted by 1806 means that the “planning system→type number” is a transform rule for transforming data transformable into “type number” of the common data item “outputted” in “planning system” into “type number” of the common data item and the transform rule definition file thereof is “¥¥COMP2¥C¥PLANNING SYSTEM¥→TYPE NUMBER.CSV”.

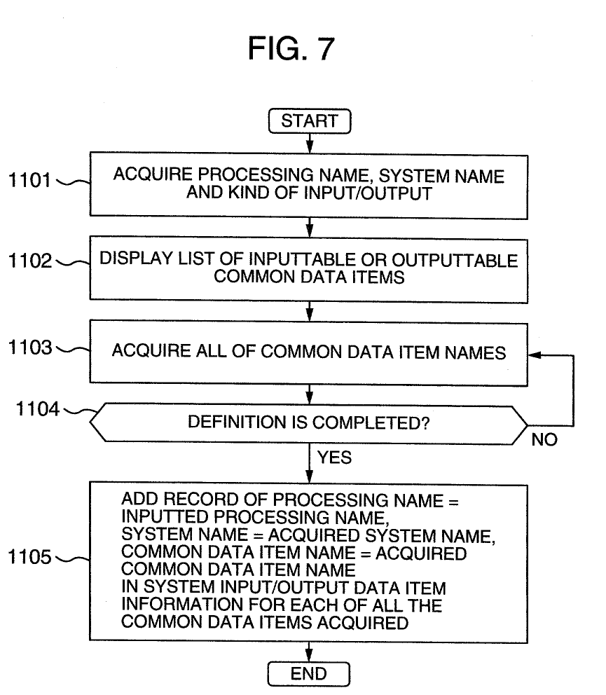

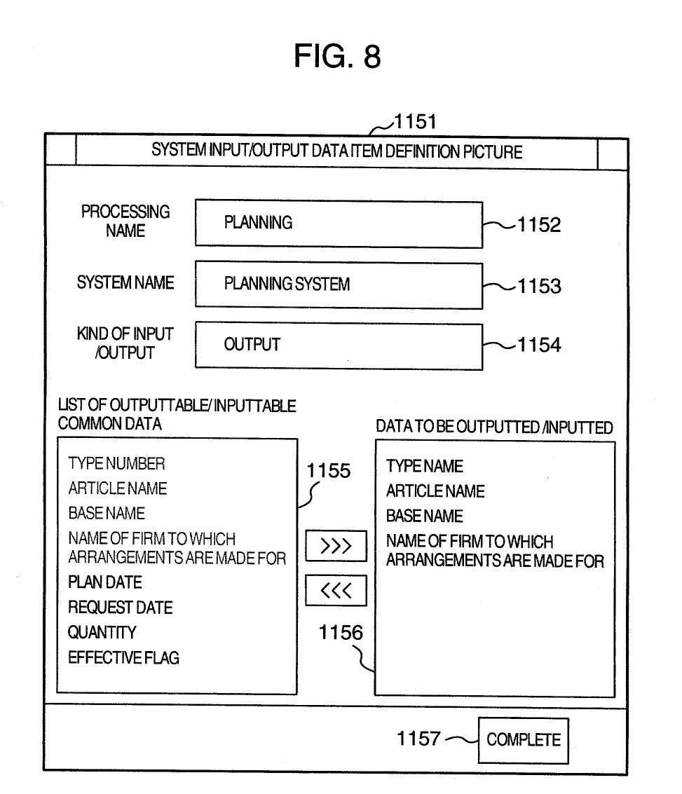

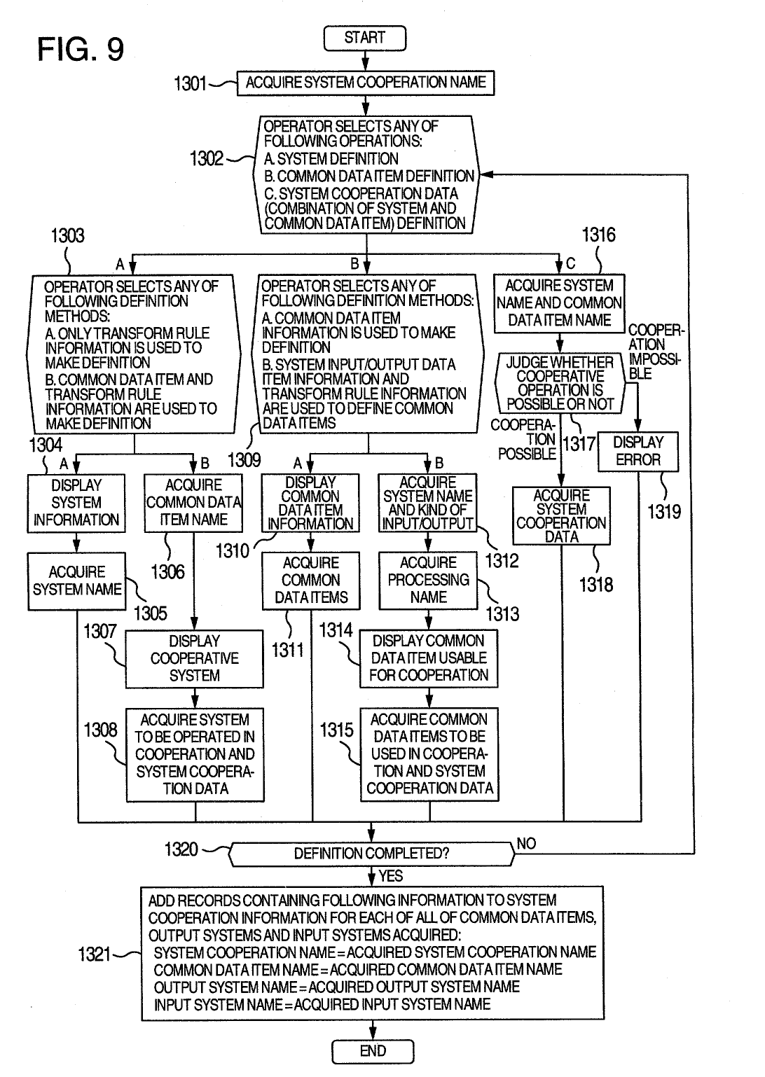

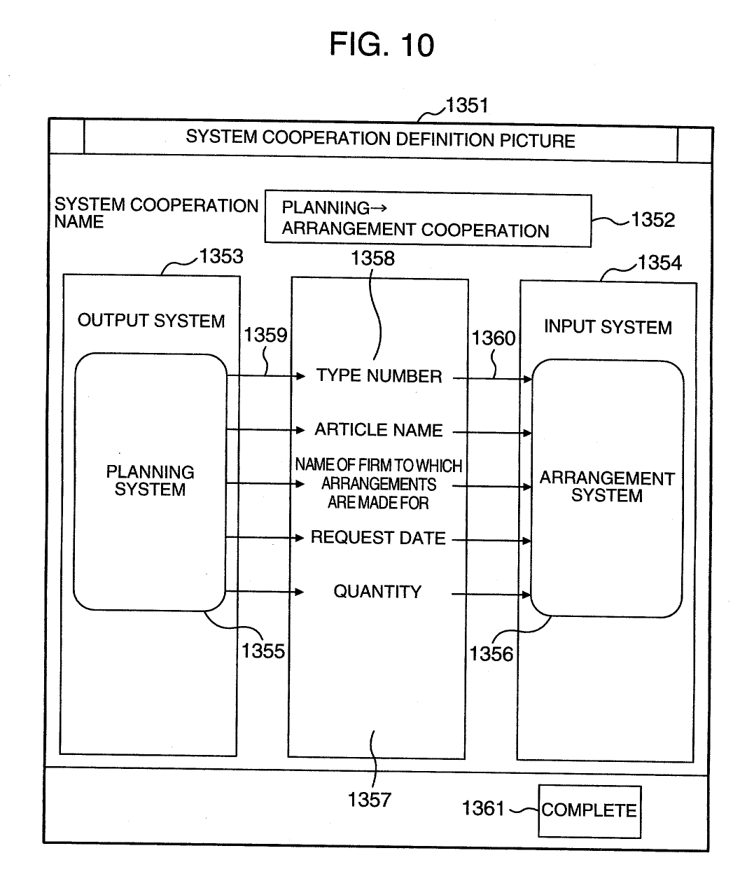

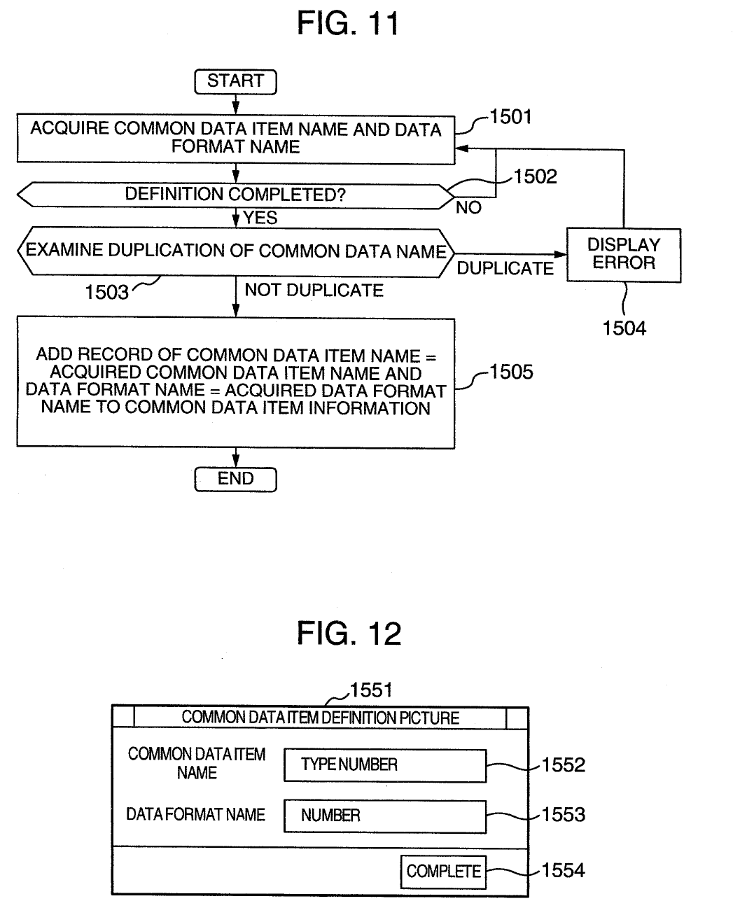

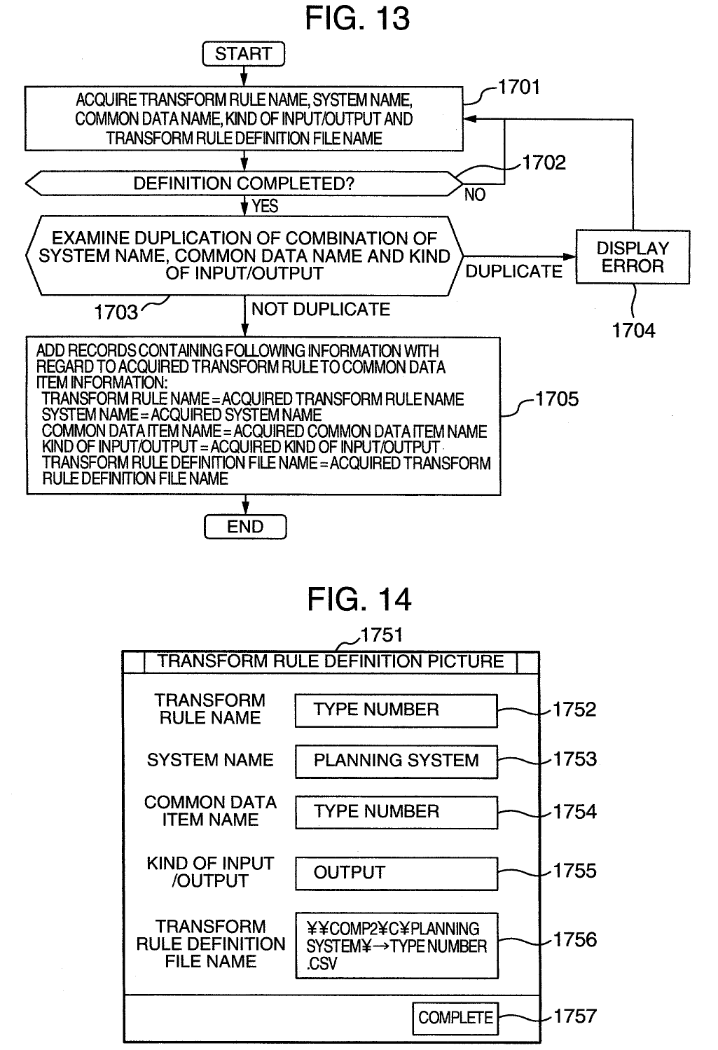

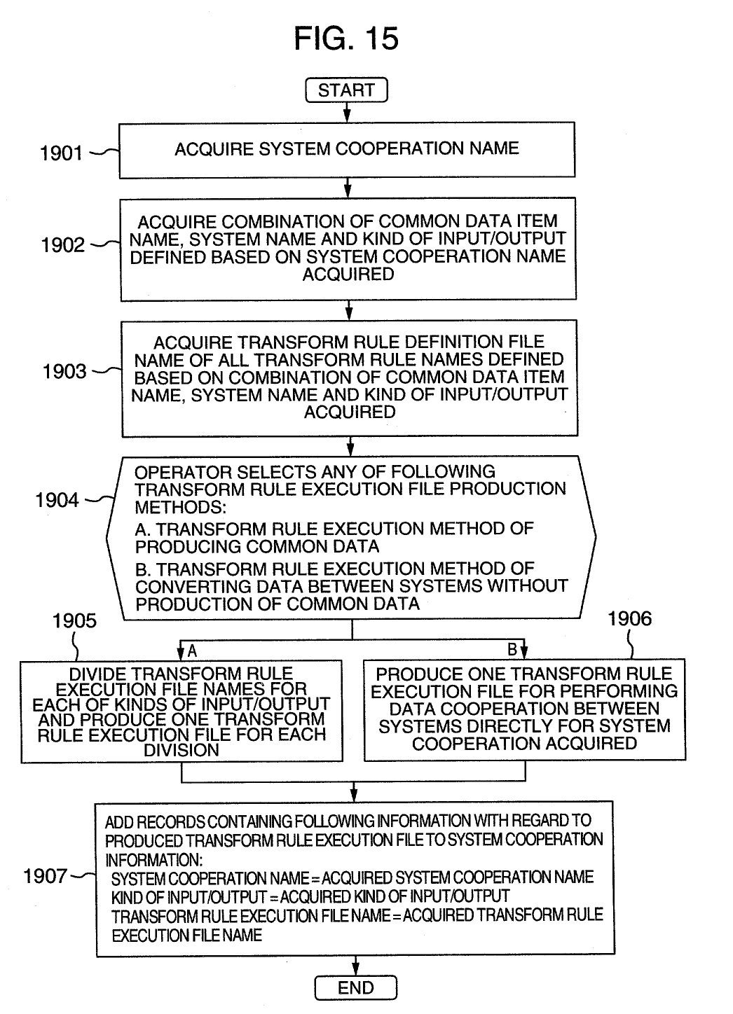

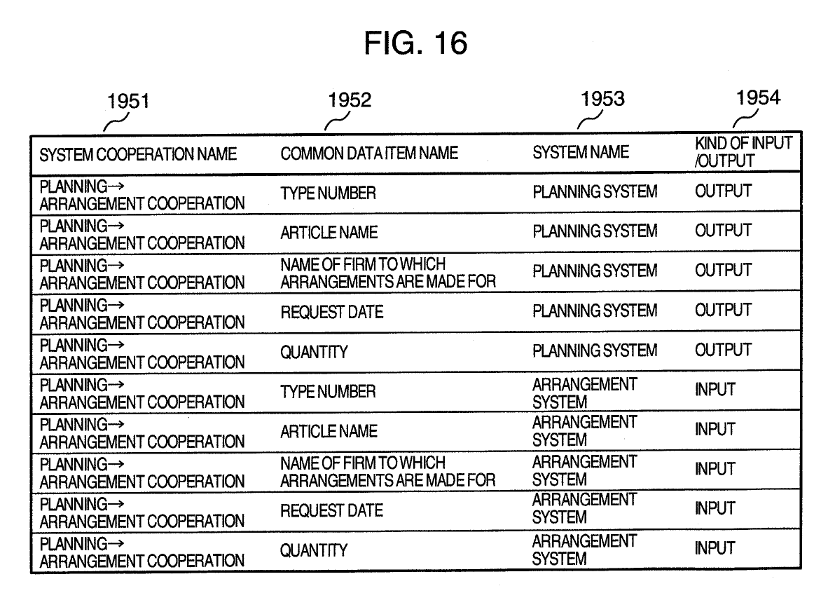

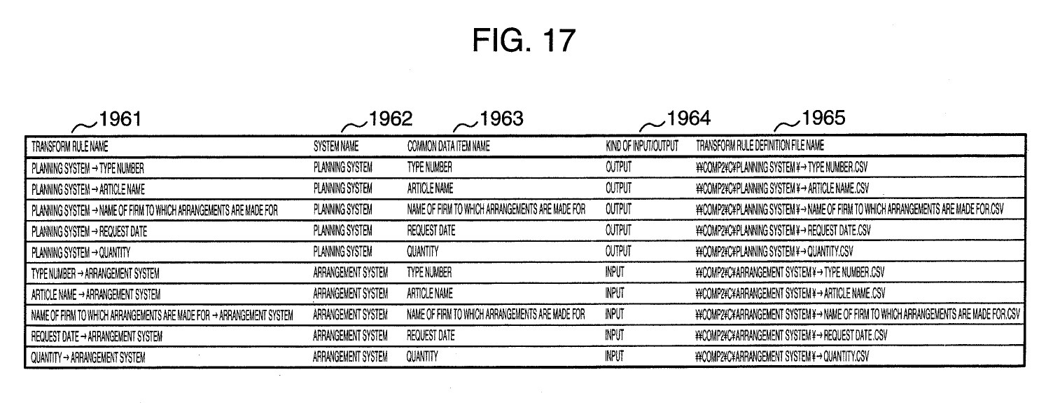

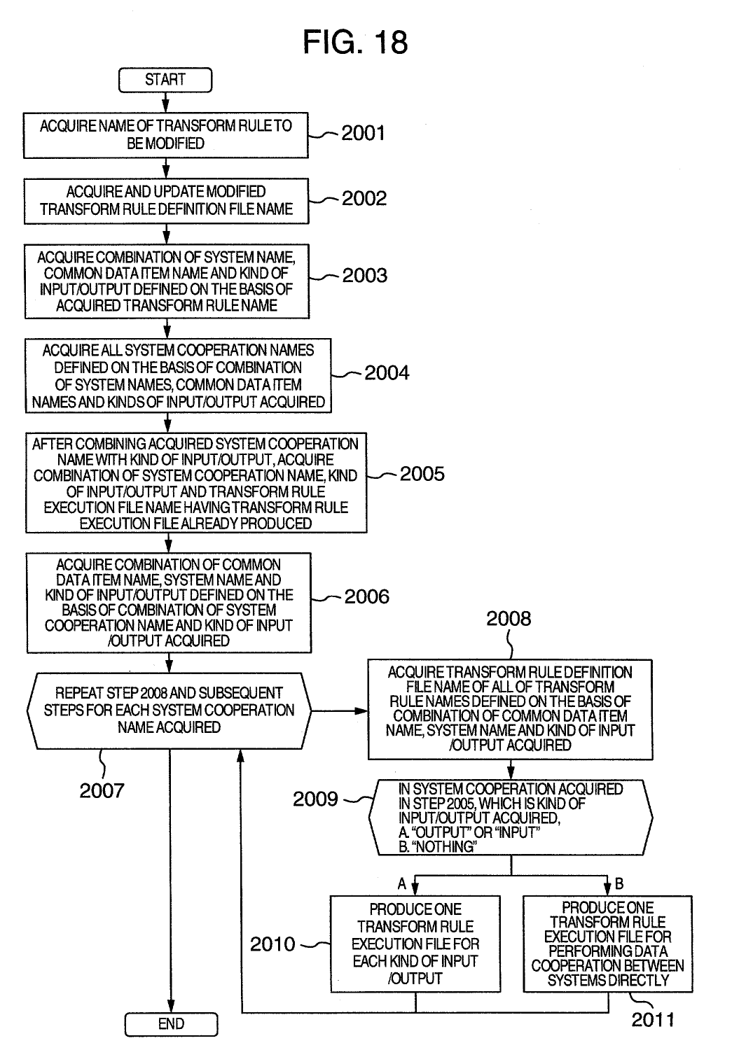

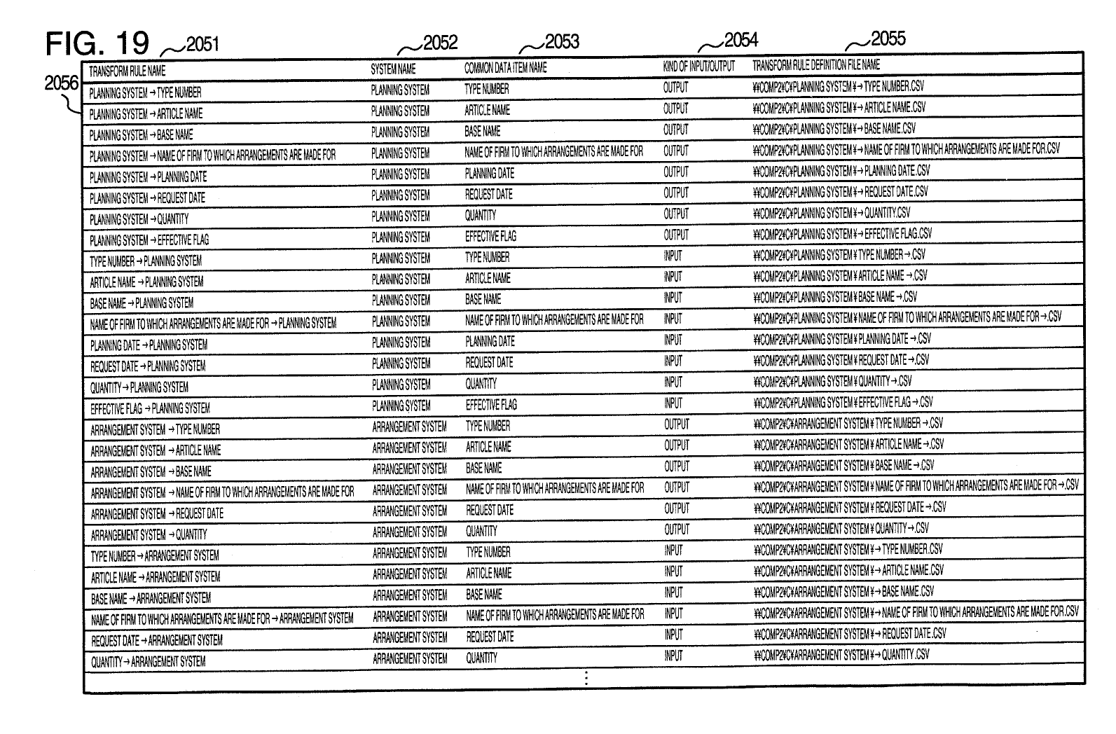

Referring now to FIGS. 2 to 6 showing data example, system input/output data definition processing shown in FIG. 7 executed by the system input/output data definition unit 11 and an example of data definition picture which is a user interface thereof shown in FIG. 8, system cooperation definition processing shown in FIG. 9 executed by the system cooperation definition unit 13 and an example of data definition picture which is a user interface thereof shown in FIG. 10, common data item definition processing shown in FIG. 11 executed by the common data item definition unit 15 and an example of data definition picture which is a user interface thereof shown in FIG. 12, transform rule definition processing shown in FIG. 13 executed by the transform rule definition unit 17 and an example of data definition picture which is a user interface thereof shown in FIG. 14, transform rule extraction processing shown in FIG. 15 executed by the transform rule extraction unit 19 and an example of data shown in FIGS. 16 and 17, and transform rule re-extraction processing shown in FIG. 18 executed by the transform rule re-extraction unit 20 and an example of data shown in FIGS. 19 to 23 are described.

First, referring to the flow chart shown in FIG. 9, the picture example shown in FIG. 10 and an example of data inputted in the picture example, an example of data definition input processing for defining the system cooperation, executed by the system input/output data definition unit 11 while the operator uses the system and the common data item is described.

FIG. 8 shows an input/output data item definition picture 1151 of the system.

In step 1101 of FIG. 7, a processing name of one data processing inputted by the operator, a system name of a system which performs processing in the data processing, and a kind of input/output of data defined in the data processing are acquired. A processing name 1152 of FIG. 8 is a field for inputting a string of characters representing the processing name and in this example “planning” is inputted. The processing name generally uses a work name or the like defined by the workflow design. A system name 1153 is a field for inputting a string of characters representing the system name. In this example, only the system name taken out without duplication from the system name 1802 of the table shown in FIG. 6 stored as the transform rule information 18 can be controlled to be selected by the operator on the picture particularly and the “planning system” is inputted in the field. A kind of input/output 1154 is a field for inputting a string of characters representing the kind of input/output. In this example, only one of “input” or “output” can be controlled to be inputted on the picture particularly and “output” is inputted.

In step 1102 of FIG. 7, a list of common data items capable of being inputted or outputted is displayed on the basis of the system name and the kind of input/output acquired. A list of common data items 1155 of FIG. 8 is a field for displaying as a list a string of characters representing common data items capable of being inputted or outputted by execution of transform rule execution unit 21 in the kind of input/output of the system. Records satisfying the condition of “system name 1802=character string inputted in system name 1153 AND kind of input/output 1804=character string inputted in kind of input/output 1154” are acquired from the table shown in FIG. 6 including the transform rule information 18 and common data item names 1803 in the records are displayed in the list of common data 1155. The list of common data 1155 displays “type number”, “article name, “base name”, “name of firm to which arrangements are made for”, “plan date”, “request date”, “quantity” and “effective flag” successively.

In step 1103 of FIG. 7, the names of common data items inputted by the operator are acquired. Data 1156 to be inputted/outputted of FIG. 8 is a field for inputting a string of characters representing common data items to be inputted or outputted by execution of the transform rule execution unit 21 and defined in the above operation by the system. In this example, by selecting the common data items displayed in the picture, input can be controlled to be made on the picture and “type number”, the article name”, “base name” and “name of firm to which arrangements are made for” are inputted.

In step 1104 of FIG. 7, it is judged whether the definition is completed or not. In FIG. 8, the operator can press a complete button 1157 by means of an input unit such as a mouse to thereby detect the completion.

In step 1105 of FIG. 7, a record of processing name 1201=acquired processing name, system name 1202=acquired system name, common data item name 1203 =acquired common data item name and kind of input/output 1204=acquired kind of input/output are added in the system input/output data item information 12 for each of all the common data items acquired.

Next, referring to the flow chart shown in FIG. 9, the picture example shown in FIG. 10 and an example of data inputted in the picture example, an example of data definition inputting processing for defining the common data item inputted/outputted in the system in one processing and executed by the system cooperation definition unit 13 is described. FIG. 10 shows a system cooperation definition picture 1351.

In step 1301 of FIG. 9, a system cooperation name which is a name of one system cooperation inputted by the operator is acquired. A system cooperation name 1352 of FIG. 10 is a field for inputting a string of characters representing the system cooperation name and in this example “plan→arrangement cooperation” is inputted.

In step 1302 of FIG. 9, the operator indicates which of “A. system definition”, “B. common data item definition” and “C. system cooperation data (combination of system and common data items) definition” is performed by means of a menu or the like. When the operator indicates A, the processing for defining the system in step 1303 and subsequent steps is performed. When the operator indicates B, the processing for defining the common data items in step 1309 and subsequent steps is performed. When the operator indicates C, the processing for defining relation to common data item and input/output of the system in step 1316 and subsequent steps is performed.

In step 1303 of FIG. 9, the operator instructs the method of performing the system definition by selecting “the method A where only the transform rule information is used to perform the definition” or “the method B where the common data item and the transform rule information are used to define the common data items” from a menu.

When the operator instructs or selects the method A, the processing for defining the system by utilizing only the transform rule information 18 is performed in step 1304 and subsequent steps and when the operator instructs or selects the method B, the processing for defining the common data items by utilizing the common data and the transform rule information 18 is performed in step 1306 and subsequent steps.

In step 1304 of FIG. 9, records are acquired from the table shown in FIG. 6 including the transform rule information 18 and a list of combinations of system names 1601 and kinds of input/output 1604 in respective records is then displayed in a sub-picture of the picture shown in FIG. 10 without duplication.

In step 1305 of FIG. 9, the system name and the kind of input/output inputted by designation of the operator are acquired to be displayed from the combinations of the system names and the kinds of input/output displayed in step 1304. A field 1353 is a field for inputting a string of characters representing an output system and a plurality of system names can be inputted in this field. An output system field 1355 is a field for displaying one of the inputted output systems. In this example, “planning system” is displayed. A field 1354 is a field for inputting a string of characters representing an input system and a plurality of system names can be inputted in this field. An arrangement system field 1356 is a field for displaying one of the input systems inputted in the field 1354. In this example, “arrangement system” is displayed.

In step 1306 of FIG. 9, the common data item name inputted by designation of the operator is acquired from among the common data item names displayed in a common data item name field 1357 of FIG. 10. In this example, “type number 1357” is supposed to be acquired.

In step 1307 of FIG. 9, records satisfying the condition of “common data item name 1803=common data item name acquired in step 1306” are acquired from the table shown in FIG. 6 including the transform rule information 18 and a list of combinations of system names 1802 and kinds of input/output 1804 is displayed in the sub-picture of the picture of FIG. 10 without duplication. The combinations of system name and kind of input/output displayed are the system and the kinds of input/output of the system capable of inputting or outputting the common data item designated by the operator in step 1306 by means of transforming processing. In this example, as a result of display of the list, “planning system” and “output”, “planning system” and “input”, “arrangement system” and “output”, and “arrangement system” and “input” are displayed.

In step 1308 of FIG. 9, a combination of system and kind of input/output designated by the operator is acquired as the system to be operated in cooperation in the system cooperation from the combinations of systems and kinds of input/output displayed as the list in step 1307. Further, the combination of system and kind of input/output acquired also holds relation to input/output as correspondence to the common data item and accordingly the relation is displayed by icon such as arrow. In FIG. 10, an arrow line 1359 for identifying that “type number 1358” is output data from the planning system and an arrow line 1360 for identifying that “type number 1358” is input data to the arrangement system are examples of the relation of the systems to the common data items.

In step 1309 of FIG. 9, the operator instructs the method of performing the common data item definition by selecting “the method A where the common data item information is used to perform the definition” or “the method B where the system input/output data item information and the transform rule information are used to define the common data items” from menu.

When the operator instructs or selects the method A, the processing for defining the common data items by utilizing the common data item information 16 is performed in step 1310 and subsequent steps and when the operator instructs or selects the method B, the processing for defining the common data items by utilizing the system input/output data item information 12 and the transform rule information 18 is performed in step 1312 and subsequent steps.

In step 1310 of FIG. 9, records are acquired from the table shown in FIG. 5 including the common data item information 16 and common data item names 1601 in respective records are then displayed as a list by means of the sub-picture of the picture of FIG. 10.

In step 1311 of FIG. 9, the common data item names inputted by designation of the operator are acquired to be displayed from the common data items displayed in step 1310. A field 1357 of FIG. 10 is a field for inputting a string of characters representing the common data item. In this example, “type number”, “article name”, “name of firm to which arrangements are made for”, “request date” and “quantity” are displayed.

In step 1312 of FIG. 9, the system name and the kind of input/output of the system inputted by designation of the operator are acquired from the system names displayed in the field 1353 or 1354 of FIG. 10. In this processing, the operator can designate two systems maximum. However, the kinds of input/output in this case must be different from each other and the kinds of input/output of the two designated systems are controlled to be different from each other on the picture. In this example, a first system name of the two systems designated by the operator is “planning system 1355” and the kind of input/output is “output” while a second system name is “arrangement system 1356” and the kind of input/output is “input”.

In step 1313 of FIG. 9, records satisfying the condition of “system name 1202=system name acquired in step 1312 AND kind of input/output 1204=kind of input/output acquired in step 1312” are acquired from the table shown in FIG. 2 including the system output data item information 12 for each system name and kind of input/output acquired in step 1312 and processing names 1201 for respective records are then displayed as a list by means of the sub-picture of the picture shown in FIG. 10 without duplication. The operator can designate one of the processing names, although the process can proceed to a next step 1314 without the operator's designation. In this example, “planning” is displayed for “planning system” and “planning” is supposed to be acquired in response to the operator's designation. Furthermore, “arrangement” is displayed for “arrangement system” and “arrangement” is supposed to be acquired in response to the operator's designation.

In step 1314 of FIG. 9, common data items having common data item names common to three tables including a first table prepared by acquiring records satisfying the condition of “processing name 1201=processing name acquired in step 1312 AND system name 1202=system name acquired in step 1312 AND kind of input/output 1204=kind of input/output acquired in step 1312” from the table shown in FIG. 2 including the system input/output data information 12, a second table prepared acquiring records satisfying the condition of “system name 1802=first system name acquired in step 1312 AND kind of input/output 1804=first kind of input/output acquired in step 1312” from the table shown in FIG. 6 including the transform rule information 18, and a third table prepared by acquiring records satisfying the condition of “system name 1802=second system name acquired in step 1312 AND kind of input/output 1804=second kind of input/output acquired in step 1312” from the table shown in FIG. 6 including the transform rule information 18 are displayed as a list by means of the sub-picture of the picture of FIG. 10. The displayed common data items are common data items capable of being inputted or outputted to the system designated by the operator in step 1312 and common data items capable of being inputted or outputted in the processing designated by the operator in step 1313. Further, when the operator does not designate the processing name in step 1313, the first table preparation processing is canceled and the above processing is performed for only the second and third tables, so that a list of common data items is displayed. In this example, as a result of the display of the list, “type number”, “article name”, “name of firm to which arrangements are made for”, “request date” and “quantity” are displayed.

In step 1315 of FIG. 9, the common data items designated by the operator, of the common data items displayed as the list in step 1314 are acquired as the common data items to be used in cooperation in the system cooperation. Further, all of the common data items displayed can be automatically acquired as the common data items to be used in cooperation in the system cooperation without the operator's designation. Further, the acquired common data items hold relation to input/output as correspondence to the input system or output system and accordingly the relation is displayed by icon such as arrow. The field 1357 of FIG. 10 is a field for inputting a string of characters representing the common data item and in this example “type number”, “article name”, “name of firm to which arrangements are made for”, “request date” and “quantity” are displayed. An arrow line 1359 for identifying that “type number 1358” is output data from the planning system and an arrow line 1360 for identifying that “type number 1358” is input data to the arrangement system are examples of the relation of the systems to the common data items.

In step 1316 of FIG. 9, a system name inputted, of the system names displayed in the field 1353 or 1354 of FIG. 10, the kind of input/output of the system and the common data items displayed in the field 1357 are acquired in response to the operator's designation. In the processing, the system and the common data which are not related to the input/output are controlled to be designated on the picture by the operator.

In step 1317 of FIG. 9, records satisfying the condition of “system name 1802=system name acquired in step 1316 AND kind of input/output 1804=kind of input/output acquired in step 1316 AND common data item name=common data item name acquired in step 1316” are acquired from the table shown in FIG. 6 including the transform rule information 18 for each of the system names, the kinds of input/output and the common data items acquired in step 1316. When the number of records acquired is 0, it means that cooperation in the combination of the system name, the kind of input/output and the common data item acquired is impossible and the processing in step 1319 is performed. When it is not 0, the cooperation is possible and the processing in step 1318 is performed. In step 1318 of FIG. 9, the combination of the system name, the kind of input/output and the common data item acquired in step 1317 is acquired as the system cooperation data and the relation of the system name to the common data items is displayed by icon such as arrow.

In step 1319 of FIG. 9, an error picture is displayed to notify the operator that cooperation is impossible.

In step 1320 of FIG. 9, it is judged whether the definition is completed or not and in FIG. 10 the completion can be detected by pressing a complete button 1361 by the operator by means of an input unit such as mouse.

In step 1321 of FIG. 9, records of system cooperation name 1401=acquired system cooperation name, common data item name 1402=acquired common data item, system name 1403=acquired output system name or input system name, and kind of input/output 1404=output for the output system or input for the input system are added in the system cooperation information 14 for each of combinations of all of the common data items and systems acquired.

Referring now to the flow chart shown in FIG. 11, the picture example shown in FIG. 12 and an example of data inputted in the picture example, an example of data definition input processing for defining the common data items which are common and general data items in the composite system, executed by the common data item definition unit 15 is described.

FIG. 12 shows a common data item definition picture 1551. In step 1501 of FIG. 11, the name of common data item and the name of data format of common data item inputted by the operator are acquired. A field 1552 of FIG. 12 is a field for inputting a string of characters representing the common data name and in this example “type number” is inputted. A field 1153 is a field for inputting a string of characters representing data format name and in this example “NUMBER” is inputted in the field 1153. In this example, only the data item name is defined as an example of the definition of the data format, while the picture may be expanded in order to define more detailed data formats such as data structure, type, code system and the table shown in FIG. 5 may be expanded in order to preserve the definition data.

In step 1502 of FIG. 11, it is judged whether the definition is completed or not and in FIG. 12 the completion can be detected by pressing a complete button 1554 by the operator by means of input unit such as mouse.

In step 1503 of FIG. 11, it is examined whether the same name as the common data name acquired in step 1501 is already defined as the common data item information 16 or not. This is made in order to uniquely identify the common data in the composite system. Records satisfying the condition of “common data name 1601=common data name acquired in step 1501” are acquired from the table shown in FIG. 5 including the common data item information 16. When the number of records acquired is 0, it means that the acquired common data name has been already defined and processing in step 1504 is performed. When it is not 0, definition is possible and processing in step 1505 is performed.

In step 1504 of FIG. 11, an error picture is displayed to thereby notify the operator that the inputted common data item has been already defined.

In step 1505 of FIG. 11, records of common data item name 1601=acquired common data item name and data format name 1602=acquired data format name are added to the common data item information 16.

Next, referring to the flow chart shown in FIG. 13, a picture example shown in FIG. 14 and an example of data inputted in this picture example, an example of the data definition input processing for defining one transform rule, that is, a transform rule in transform processing of one system and one common data item of input or output of the system, executed by the transform rule definition unit 17 is described. FIG. 14 shows a transform rule definition picture 1751.

In step 1701 of FIG. 13, a name of transform rule in one transform processing, a name of system to be transformed by the transform rule, name of common data item to be inputted or outputted by the transform to the system and kind of input/output of the common data item in the transform rule inputted by the operator are acquired.

A field 1752 of FIG. 14 is a field for inputting a string of characters representing the transform rule name and in this example “planning system→type number” is inputted in the field 1752. A field 1753 is a field for inputting a string of characters representing the system name and in this example “planning system” is inputted in the field 1753. A field 1754 is a field for inputting a string of characters representing the common data item. In this example the operator can be controlled to select only the common data item name taken out from the common data item name 1601 in the table shown in FIG. 5 including the common data item information 16 on the picture particularly and “type number” is inputted in the field 1754. A field 1755 is a field for inputting a string of characters representing kind of input/output. In this example only any of “input” or “output” can be controlled to be inputted on the picture particularly and “output” is inputted. A field 1756 is a field for inputting a string of characters representing the transform rule definition file name and in this example “¥¥COMP2¥C¥planning system¥→type number.CSV” is inputted in the field 1756. In this example, a transform rule definition file in which detailed information of the transform rule is stored is previously prepared by the operator and preserved as an example of the definition of the transform rule and only the transform rule definition file name is defined in the transform rule definition picture 1751. In this method, information referred to upon preparation of the transform execution file is information stored in the transform rule definition file specified by the transform rule definition file name in the processing of the transform rule execution unit 21 described later. However, the method of defining the detailed information of the transform rule is not limited to this example and there is also a method that the picture is expanded in order to define more detailed transform rules such as input/output data name of the system, the data format thereof, the transform program and the like and the table shown in FIG. 6 is expanded in order to preserve the definition data. In this method, it is not necessary to define the transform rule definition file name and accordingly the field 1756 of FIG. 14 and the transform rule definition file name 1805 of FIG. 6 are not necessary.

In step 1702 of FIG. 13, it is judged whether the definition is completed or not. In FIG. 14, the completion can be detected by pressing a complete button 1757 by the operator by means of input unit such as mouse.

In step 1703 of FIG. 13, it is examined whether the same combination as that of the system name, the common data name and the kind of input/output acquired in step 1701 are already defined in the transform rule information 18 or not. This is made in order to uniquely identify the combination in the composite system. Records satisfying the condition of “system name 1802=system name acquired in step 1701 AND common data item name 1803=common data item name acquired in step 1701 AND kind of input/output 1804=kind of input/output acquired in step 1701” are acquired from the table shown in FIG. 6 including the transform rule information 18. When the number of records acquired is 1, it means that the transform rule by the combination of the system name, the common data name and the kind of input/output acquired has been already defined and processing in step 1704 is performed. When it is not 1, it can be defined and processing in step 1705 is performed.

In step 1704 of FIG. 13, an error picture is displayed to thereby notify the operator that the inputted common data item has been already defined.

In step 1705 of FIG. 13, records of transform rule name=acquired transform rule name, system name=acquired system name, common data item name=acquired common data item name, kind of input/output=acquired kind of input/output and transform rule definition file name=acquired transform rule definition file name with regard to the acquired transform rule are added to the transform rule information 18.

Next, referring to the flow chart shown in FIG. 15 and an example of tables shown in FIGS. 16 and 17, an example of extraction processing of the transform rule based on the system cooperation data and production processing of the transform rule execution file based on the transform rule, executed by the transform rule extraction unit 19 is described.

In step 1901 of FIG. 15, a system cooperation name inputted by the operator is acquired. In this example, only the system cooperation name taken out without duplication from the system cooperation name 1401 in the table shown in FIG. 3 including the system cooperation information 14 can be controlled to be selected and inputted by the operator on the picture and in this example “planning→arrangement cooperation” is supposed to be inputted as the system cooperation name.

In step 1902, a first table prepared by acquiring records satisfying the condition of “system cooperation name 1401=system cooperation name acquired in step 1901” from the table shown in FIG. 3 including the system cooperation information 14 is acquired. The table shown in FIG. 16 is an example of the first table. The records of the table shown in FIG. 16 indicate all combinations of the common data name 1952, the system name 1953 and the kind of input/output 1954 defined in the system cooperation name 1951 acquired in step 1901.

In step 1903, all records in the first table are combined to a table prepared by acquiring records satisfying the condition of “system name 1602=system name in the records in the first table AND common data item name 1603=common data item name in the records in the first table AND kind of input/output 1604=kind of input/output in the records in the first table” from the table shown in FIG. 6 including the transform rule information 18 to thereby prepare a second table. The table shown in FIG. 17 is an example of the second table. In the table shown in FIG. 17, each record indicates a combination of the kind of input/output 1964 and the transform rule definition file name 1965 required in the system cooperation name acquired in step 1901.

In step 1904, the operator instructs the method of producing the transform rule execution file by selecting “the transform rule execution method A of producing common data” or “the transform rule execution method B of transforming data between systems without production of common data” from a menu.

When the operator instructs the method A, the processing for producing the transform rule execution file for producing common data of step 1905 is performed and when the operator instructs the method B, the processing for producing the transform rule execution file for transforming data between systems directly without production of common data of step 1906 is performed.

In step 1905, all of transform rule definition files having the kind of input/output set to “output” are referred to from the second table to thereby transform the output data from the system to produce one transform rule execution file which produces the common data. Further, in parallel with this processing, all of transform rule definition files having the kind of input/output set to “input” are referred to thereby transform the common data to produce one transform rule execution file which produces input data of the system.

In step 1906, all of the kinds of input/output and the transform rule definition files are referred to from the second table to thereby produce one transform rule execution file which transforms the output data of the system into the input data of the system directly.

As an example of processing in production of the transform rule execution file in steps 1905 and 1906, there is the method disclosed in the prior art 2, while it is not limited to this method. Further, the name of the transform rule execution file produced can be defined to any name by the operator.

In step 1907, records of system cooperation name=system cooperation name acquired in step 1901, kind of input/output=referred kind of input/output when the processing of step 1905 is performed and “nothing” when the processing of step 1906 is performed, and transform rule execution file name=produced transform rule execution file name with regard to the produced transform rule execution file are added to the system cooperation information 14. In this processing, when the processing of step 1905 has been performed, two transform rule execution files having the kinds of input/output set to “output” and “input” are sometimes produced and accordingly in this case two records are added.

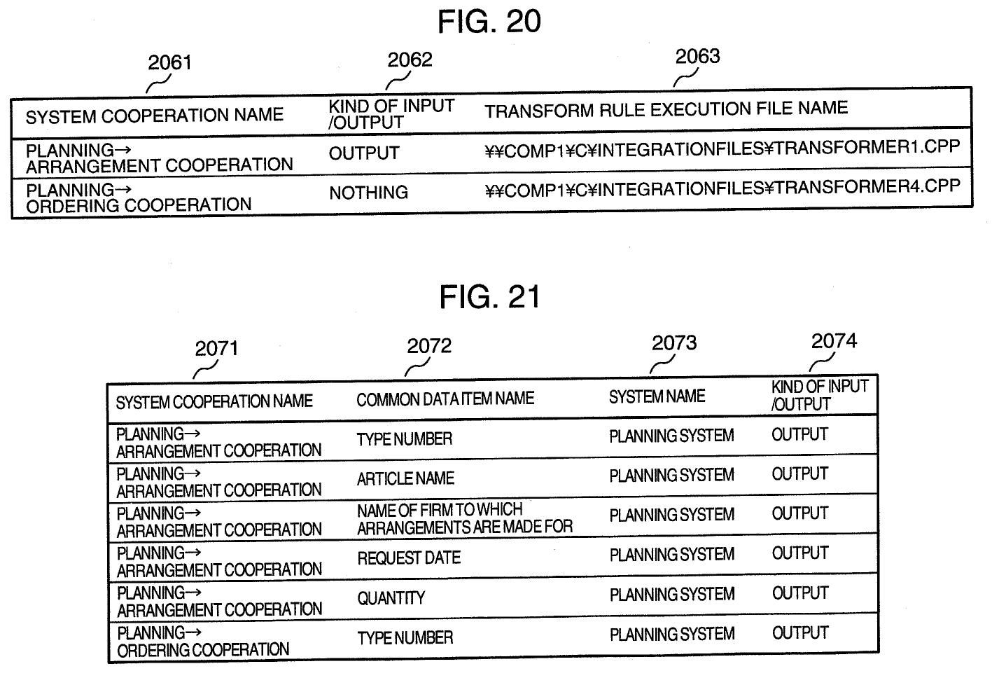

Next, referring to the flow chart shown in FIG. 18 and an example of tables shown in FIGS. 19 and 20, an example of processing for producing the transform rule execution file again when contents of definition of the transform rule included in the transform rule information 18, executed by the transform rule re-extraction unit 20 is modified is described.

In step 2001 of FIG. 18, a name of the transform rule to be modified and inputted by the operator is acquired. In this example, the transform rule name acquired can be controlled to be selected and inputted by the operator from the table shown in FIG. 6 including the transform rule information 18 on the picture particularly and “planning system→type number” is supposed to be inputted.

In step 2002, the modified transform rule definition file name inputted by the operator with regard to the transform rule name acquired in step 2001 is acquired and the transform rule definition file name 1605 of record of “transform rule name 1601=transform rule name acquired in step 2001” in the table shown in FIG. 6 including the transform rule information 18 is modified to the acquired transform rule definition file name. In this example, “¥¥COMP2¥C¥planning system¥→type number2.CSV” is supposed to be acquired as the modified transform rule definition file name. FIG. 19 shows an example of the table including the modified transform rule information 18 and particularly it is understood that record represented by 2056 is updated.

In step 2003, a system name 2052, a common data item name 2053 and a kind of input/output 2054 in a record satisfying the condition of “transform rule name 2051=transform rule name acquired in step 2001” in the table shown in FIG. 19 including the transform rule information 18 are acquired. This means a combination of system, common data item and kind of input/output requiring the transform rule name acquired in step 2001. In this example, “planning system” as the system name, “type number” as the common data item name and “output” as the kind of input/output are acquired.

In step 2004, with regard to the combination of the system name, the common data item name and the kind of input/output acquired in step 2003, system cooperation names 1401 in all records satisfying the condition of “common data item name 1402=common data item name acquired in step 2003 AND system name 1403=system name acquired in step 2003 AND kind of input/output 1404=kind of input/output acquired in step 2003 or ‘nothing’” in the table shown in FIG. 3 including the system cooperation information 14 are acquired without duplication. This means the system cooperation requiring the transform rule name acquired in step 2001. In this example, only “planning→arrangement cooperation” is acquired as the system cooperation name.

In step 2005, with regard to all of the system cooperation name acquired in step 2004, a first table prepared by acquiring records satisfying the condition of “system cooperation name 1411=system cooperation name acquired in step 2004” in the table shown in FIG. 4 including the system cooperation information 14 is acquired. FIG. 20 shows an example of the first table. In the table shown in FIG. 20, each record indicates a combination of the system cooperation name 2061, the kind of input/output 2062 and the transform rule execution file name 2063 having the transform rule execution file already produced by using the transform rule name acquired in step 2001.

In step 2006, with regard to all the records of the first table acquired in step 2005, records satisfying the condition of “system cooperation name 1401=system cooperation name in the records AND kind of input/output=kind of input/output in the records” are acquired from the table shown in FIG. 3 including the system cooperation information 14 in case of the kind of input/output in the records≠“nothing” and records satisfying the condition of “system cooperation name 1401=system cooperation name in the records” are acquired from the table in case of the kind of input/output in the records=“nothing”, so that a second table is prepared by combining both the records acquired as above. FIG. 21 shows an example of the second table. The records of the table shown in FIG. 21 indicate all combinations of the system cooperation name 2071, the common data name 2072, the system name 2073 and the kind of input/output 2074 defined in the combination of the system cooperation name 2061 and the kind of input/output 2062 acquired in step 2005.

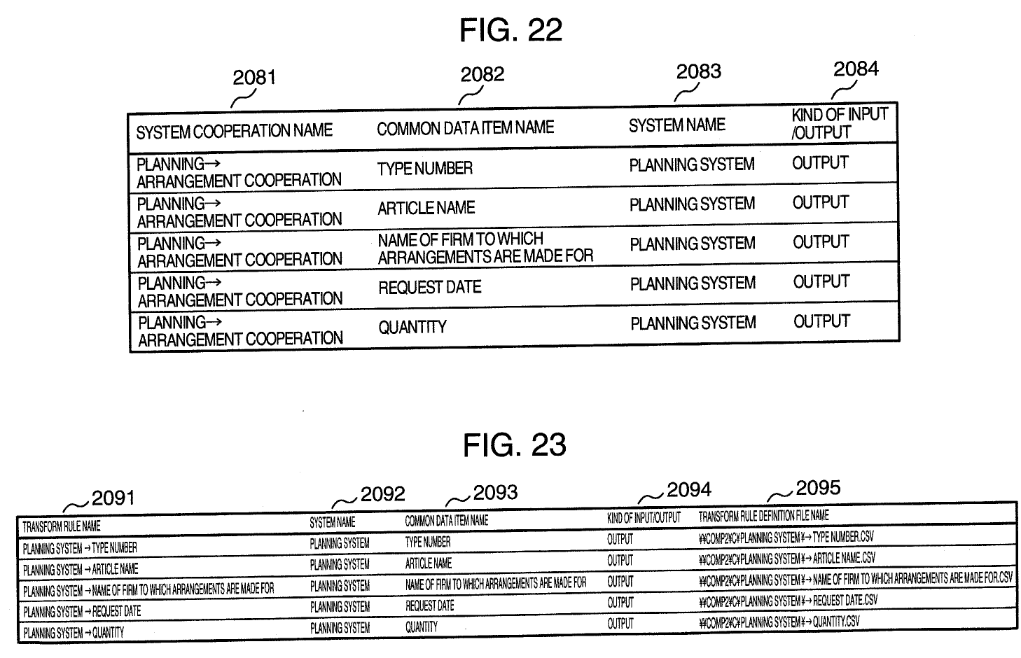

In step 2007, the second table is separated for each system cooperation name to prepare third tables and the processing in step 2008 and subsequent steps is repeated for each table. FIG. 22 shows an example of the third table in case of system cooperation name=“planning→arrangement cooperation”.

In step 2008, with regard to all the records of the third table, a fourth table prepared by further combining a table prepared by acquiring records satisfying the condition of “system name 2052=system name in the records AND common data item name 2053=common data item name in the records AND kind of input/output 2054=kind of input/output in the records” from the table shown in FIG. 19 including the transform rule information 18 is acquired. FIG. 23 shows an example of the fourth table. Each record of the table shown in FIG. 23 indicates a combination of the kind of input/output 2054 and the transform rule definition file name 2055 required in the system cooperation name.

In step 2009, in the system cooperation, when the kind of input/output acquired in step 2005 is “A. ‘output’ or ‘input’”, the processing for producing the transform rule execution file for producing the common data of step 2010 is performed and when it is “B. ‘nothing’”, the processing for producing the transform rule execution file for directly transforming data between systems of step 2011 is performed.

In step 2010, referring to all the transform rule definition files from the fourth table, one transform rule execution file for producing the common data by transforming the output data from the system is produced or one transform rule execution file for producing the input data of the system by transforming the common data is produced.

In step 2011, referring to all of the kinds of input/output and the transform rule definition files from the fourth table, one transform rule execution file for transforming the output data of the system into the input data of the system directly is produced.

The transform rule execution file produced in steps 2010 and 2011 is preserved to overwrite the same name as the transform rule execution file acquired in step 2005.

As described above, the minimum transform rule required to transmit and receive data between the plurality of systems can be extracted to thereby reduce maintenance time and labor for change in specifications of the system.

It should be further understood by those skilled in the art that the foregoing description has been made on embodiments of the invention and that various changes and modifications may be made in the invention without departing from the spirit of the invention and the scope of the appended claims.

1. A data transform method of extracting a data transform rule for transforming data having a data format required to transmit and receive data between a plurality of systems into data having another data format, comprising steps of:
using a first data item, a first system and a first kind of input/output of a first input/output data item of said first system, and a transform rule between an input/output data item of a system and a data item, which is defined for a combination of a system, a data item and a kind of input/output of an input/output data item of a system as an input; and
extracting a first transform rule of said first input/output data item and said first data item in a transform rule extraction unit.

2. A data transform method according to claim 1, comprising steps of:
displaying a first icon representing said first system;
displaying a second icon representing said first data item;
displaying a third icon representing correspondence of said first system and said first data item; and
displaying a fourth icon representing said first kind of input/output.

3. A data transform method according to claim 1, comprising steps of:
using a plurality of first data items, a plurality of first systems and a plurality of first kinds of input/output of a plurality of first input/output data items of said first systems, and a plurality of transform rules between a plurality of input/output data items of systems and a plurality of data items, which are defined for combinations of systems, data items and kinds of input/output of input/output data items of systems as an input; and
extracting a plurality of first transform rules of said plurality of first input/output data items and said plurality of first data items.

4. A data transform method according to claim 1, comprising steps of:
using said first data item, said first system and said first kind of input/output, and a transform rule between an input/output data item of a system and a data item, which is defined for a combination of a system, a data item and a kind of input/output of an input/output data item of a system as an input; and
judging whether said first transform rule of said first input/output data item and said first data item can be extracted or not and, when it cannot be extracted, displaying it.

5. A data transform method according to claim 1, comprising steps of:
using said first system and said first kind of input/output, and a transform rule between an input/output data item of a system and a data item, which is defined for a combination of a system, a data item and a kind of input/output of an input/output data item of a system as an input; and
extracting data item from which a transform rule can be extracted and displaying it.

6. A data transform method according to claim 1, comprising steps of:
using said first data item and said first kind of input/output, and a transform rule between an input/output data item of a system and a data item, which is defined for a combination of a system, a data item and a kind of input/output of an input/output data item of a system as an input; and
extracting system from which a transform rule can be extracted and displaying it.

7. A data transform method according to claim 1, comprising:
extracting, as said first data item, a data item capable of being defined as an input/output data item in one processing of said first system.

8. A data transform method according to claim 1, comprising:
producing one transform execution file from all transform rules using input data of said first input/output data as an input of the transform rule and further producing one transform rule execution file on the basis of all transform rules using output data of said first input/output data as an input of the transform rule, as a plurality of transform rules extracted by said transform rule extraction unit.

9. A data transform method according to claim 3, comprising:
producing one transform rule execution file on the basis of all transform rules in which output data of the system is input data and all transform rules in which input data of the system is output data, as the plurality of transform rules extracted by said transform rule extraction unit.

10. A data transform method according to claim 8, comprising:
replacing a first transform rule by a second transform rule, extracting a transform rule again and producing a transform rule execution file, when said first and second transform rules are used as input and a first transform rule execution file is already produced by said transform rule extraction unit on the basis of said first transform rule.

11. A data transform method according to claim 9, comprising:
replacing a first transform rule by a second transform rule, extracting a transform rule again and producing a transform rule execution file, when said first and second transform rules are used as input and a first transform rule execution file is already produced by said transform rule extraction unit on the basis of said first transform rule.

12. A data transform method comprising steps of:
dividing uniquely identifiable systems into input systems and output systems to be defined and causing an operator to define data item to be delivered from said input system to said output system using common data item defined generally in common within a composite system to store it as system cooperation information in a system cooperation information management unit;
causing the operator to define a transform rule for each system and common data item and storing said transform rule in a transform rule information management unit;
extracting a necessary transform rule from said transform rule information management unit on the basis of said system cooperation information automatically; and
loading said transform rule.

13. A data transform system for extracting a data transform rule for transforming data having a data format required to transmit and receive data between a plurality of systems into data having another data format, comprising:
means for using a first data item, a first system and a first kind of input/output of a first input/output data item of said first system, and a transform rule between an input/output data item of a system and a data item, which is defined for a combination of a system, a data item and a kind of input/output of an input/output data item of a system as an input; and
means for extracting a first transform rule of said first input/output data item and said first data item.

14. A data transform program for extracting a data transform rule for transforming data having a data format required to transmit and receive data between a plurality of systems into data having another data format, comprising:
an instruction for using a first data item, a first system and a first kind of input/output of a first input/output data item of said first system, and a transform rule between an input/output data item of a system and a data item, which is defined for a combination of a system, a data item and a kind of input/output of an input/output data item of a system as an input; and
an instruction for extracting a first transform rule of said first input/output data item and said first data item.
